(19) United States
(12) Patent Application Publication
(10) Pub. No.: US 2008/0035688 A1
(43) Pub. Date: Feb. 14, 2008

(54) Loading System for Vehicle Roofrack

(75) Inventor: Larry D. Malone, Cape Elizabeth, ME (US)

Correspondence Address: BOHAN, MATHERS & ASSOCIATES, LLC, PO BOX 17707, PORTLAND, ME, 04112-8707, US

(73) Assignee: Malone Paddle Gear, Westbrook, ME (US)

(21) Appl. No.: 11/835,078

(22) Filed: Aug. 7, 2007

Related U.S. Application Data
(60) Provisional application No. 60/836,215, filed on Aug. 8, 2006.

(51) Int. Cl. B60R 9/00

(52) U.S. Cl. 224/310

(57) ABSTRACT

A loader for loading a kayak or other article onto a roofrack carrier. Typically two carriers are mounted on a roofrack and loader is used for each carrier. Each loader has a loading cradle that is slidably mounted in a slide rail and an attachment plate for attaching the slide rail to a carrier. A kayak is supported in the two loading cradles. Each cradle is pushed up the slide rail to lift the kayak near to the carrier. The lifting can be done by a single person in steps. A locking mechanism holds the loading cradle in position on the slide rail and prevents it from sliding backward. The user may move from one loader to the other to sequentially push the loading cradles up the two slide rails, thereby bringing the kayak close to the carriers mounted on the roofrack and in position for loading into the carriers.

### BACKGROUND INFORMATION

### Field of the Invention

The invention relates to the field of roof carriers. More particularly, the invention relates to devices for loading objects onto a roofrack carrier.

### BRIEF SUMMARY OF THE INVENTION

The invention is a loading system for loading an article onto a vehicle roofrack. Typically, articles such as bicycles, kayaks, canoes, etc. are held in carriers that are mounted to crossbars of a roofrack. The carrier is often specifically adapted to carry a particular article. For example, a kayak carrier has a cradle section in which the kayak nests. Typically, a pair of carriers are mounted on the roofrack, so as to support the article at two locations. A well known example is the conventional method of transporting a kayak. Two carriers are mounted on the crossbars of the roofrack, one toward the front and one toward the rear of the vehicle. Kayaks and other articles transported on vehicle roofracks are bulky and often heavy, and it can be very difficult, particularly for a single person, to load the article into the carrier.

The invention is a loading system for lifting an article to be transported on a vehicle roofrack into a carrier that is mounted on the roofrack. For purposes of illustration, the article to be transported is a kayak and two kayak carriers are mounted on two crossbars on the roofrack. It is understood, however, that the loading system according to the invention is not limited to loading kayaks.

The loading system has a loading slide, a loading cradle, and an attachment plate. One loading system is attached to each carrier mounted on the roofrack. The attachment plate is used to attach the loading slide to the carrier. The loading cradle has a slide bar that is slidingly captured in the loading slide and allows the loading cradle to be moved up and down along the slide. A stop mechanism holds the loading cradle in position and prevents it from inadvertently sliding down the loading slide.

In the following description of use of the system, it is assumed that the article to be transported is a kayak, although the system is well suited to load other types of articles, such as canoes. It is also assumed that two kayak carriers are mounted on the roofrack. To use the loading system, the loading cradle is moved to the lowest position on the loading slide of each loading system. The kayak is placed in the two loading cradles. The first cradle is then moved upward some distance and held in that position by the stop mechanism. At this point, the user may let go of the first loading cradle and turn to the second loading cradle; the first loading cradle will stay in position. Each loading cradle is moved up the loading slide alternately, or at the same time, if two people are available to manipulate the loading cradles at the same time. The cradles are moved up to the top of the loading slide. In this position, the kayak is now close to the carrier. Ideally, the carrier has a loading ramp and the user need only push the kayak up the loading ramp, until it drops into the cradle on the carrier.

### BRIEF DESCRIPTION OF THE DRAWINGS

The present invention is described with reference to the accompanying drawings. In the drawings, like reference numbers indicate identical or functionally similar elements. The drawings are not drawn to scale.

FIG. 1 is a side elevational view of the loading system according to the invention.

FIG. 2 is a side view of the loading system of FIG. 1.

FIG. 2A is a perspective view of the loading system illustrating the attachment of the attachment plate to the slide rail to the loading ramp on the carrier and to the slide rail.

FIG. 2B is a perspective view of the flat plate with cradle.

FIG. 3 is an illustration of the slide rail showing the stop button in its biased position.

FIG. 4 is a side elevational view of the loading cradle.

FIG. 5 shows the slide bar captured in the slide rail and partially depressing the stop button.

FIG. 6A shows a bearing block mounted on the slide rail.

FIG. 6B is a cross-sectional view of one embodiment of the slide rail, with a locking pin inserted into the slide rail.

FIG. 7 shows the loading system lowered into position for loading, with a kayak loaded into the loading cradles.

FIG. 8 shows the loading system raised to its uppermost position, with the kayak already pushed into the carrier cradles.

FIG. 9 illustrates a ramp track in the slide rail.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be complete and will fully convey the scope of the invention to those skilled in the art.

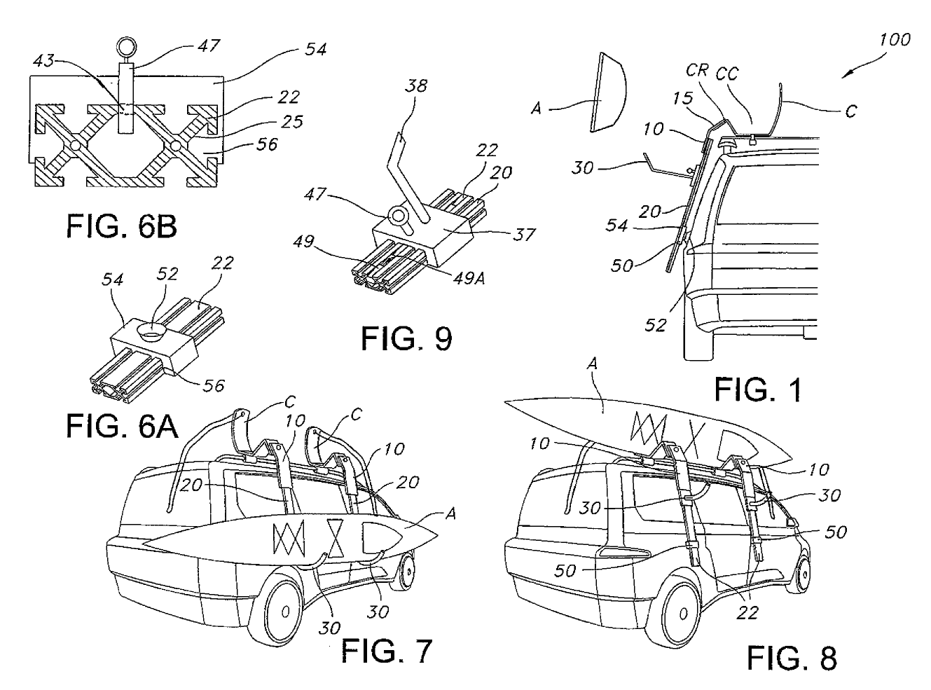

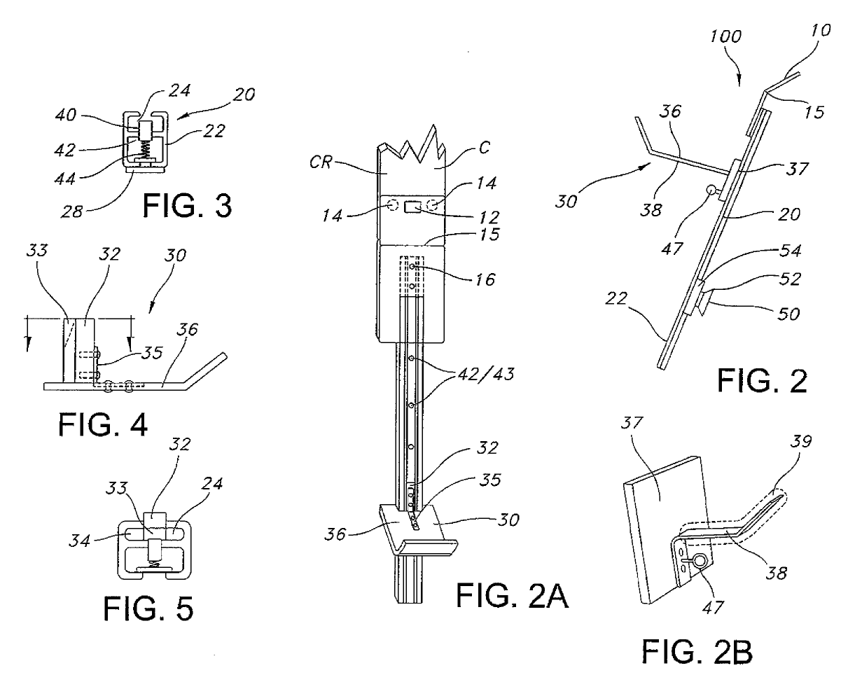

FIG. 1 shows the loading system 100 according to the invention mounted on a vehicle. The vehicle is only partially shown. An article A is to be loaded into a carrier C. For purposes of illustration, the article is a kayak and the carrier is a kayak carrier having a cradle CC and a carrier loading ramp CR. FIG. 2 is a side view of the loading system 100. The loading system 100 comprises an attachment plate 10, a loading slide 20, and a loading cradle 30. The attachment plate 10 is securely attached to the loading ramp CR by conventional fasteners 12. FIG. 2A shows details of the attachment plate 10. The loading ramp CR has two bores and anchor pins 14 are provided on the attachment plate 10 that fit into the bores and prevent the attachment plate 10 from rotating about the fastener 12. The fastener shown is a threaded fastener with a knob for easy manual turning. The knob is on the back side of the plate and is not shown. The attachment plate 10 has a flexible hinge 15, also referred to as a living hinge, to provide the necessary flexibility to accommodate the geometries of any vehicle on which the loading system 100 is mounted. Alternatively, the attachment plate 10 may be constructed as a bi-planar plate in which two ends of the plate are angled in a fixed relationship relative one another, so as to accommodate the geometries of most vehicles. The loading cradle 30 may be constructed in various ways, such as a bi-planar plate 36 shown in FIG. 2A and a curved bar 38 shown in FIG. 2B. The curved bar 38 is mounted on a slide plate 37. Side channels 25 on the slide rail 22 receive and capture keys formed on the slide plate 37, such that the slide plate 37 is slidably movable along the slide rail 22. An illustration of this slide mounting on a rail is shown below with the embodiment shown in FIG. 9. A protective covering 39 may be pulled over the bar 38 to provide a cushion and prevent damage or marring of the article A when it is supported on the bar. Suitable types of coverings include a rubber or plastic covering, a foam tube, or other suitable cushioning and non-slip material.

FIG. 3 shows details of one embodiment of the loading slide 20, which comprises a slide rail 22, a slide channel 24, and a stop mechanism 40. In this embodiment, the stop mechanism 40 is a stop button 42 that is attached to a spring 44 that is mounted in a lower channel of the rail 22. The upper channel is the slide channel 24. The spring 44 biases the stop button 42 to extend into the slide channel 24. Other suitable stop mechanisms are discussed below. locking pin The rear side of the slide rail 22 is ideally backed with a foam or other type of shock absorbing material 28, to protect the article A from damage.

FIG. 4 is a side elevational view of the loading cradle 30, which comprises a support cradle 36 and a slide bar 32. FIG. 5 is a top planar view of the slide bar 32 in the slide rail 22. The slide bar 32 has slide extensions 34 that are slidably captured in the slide channel 24. The upper end of the slide bar 32 has a sloped surface 33. As the slide bar 32 is pushed along the slide rail 22, the sloped surface 33 approaches the stop button 42 gradually, allowing the slide bar 32 to depress and continue to slide over the button 42. Once the bottom edge of the slide bar 32 has passed the button 42, it returns to its biased position, thereby preventing the loading cradle 30 from sliding back down the slide rail 22. In the embodiment shown, the slide bar 32 is fixedly mounted to the support cradle 36 by means of a bracket 35 by means of rivets or threaded fasteners or some other suitable fastening system.

FIGS. 6A and 6B show details of a second embodiment of the loading slide 20 that includes a rail support means 50 that includes a suction device 52 (shown in FIG. 2) mounted on a bearing block 54. The slide rail 22 in this embodiment is a T-slot extruded rail with channels 25 for receiving slide keys 56 provided on the bearing block 64. In the embodiment shown, the bearing block has four keys 56 that fit into the four channels 25 provided in the slide rail 22. It is understood, however, that the bearing block 54 may have only two keys 56, the two for engaging the channels either along the sides or along the upper surface of the slide rail. Referring to FIG. 1, the rail support means 50 is shown attached to the side of the vehicle on which the loading system 100 is mounted. The bearing block 54 fits on the slide rail 22 with a slight friction fit, so that it stays in place on the rail 22 under normal conditions, but slides along the slide rail 22 to any desired position, when a small amount of force applied to it. Thus, the rail support means 60 is easily adjustable for any type of vehicle on which the loading system 100 is mounted. In the embodiment shown in FIGS. 1 and 2, only one rail support means 50 is provided on the slide rail 22, although it is understood that two or more such devices may be implemented. The purpose of the rail support means 50 is to stabilize the loading system 100 during loading and unloading operations. When loading or unloading an article A onto the carrier C, the weight of the article A exerts a downward force on the slide rail 22. Depending on how the article A is balanced in the cradle 30, the downward force may have a horizontal component to it, which could force the slide rail 22 to swing to one side or the other. Applying the suction device 52 to the side of the vehicle stabilizes the slide rail 20 sufficiently, to prevent the rail from tilting to the side when the article A is being loaded. The suction device 52 also eliminates the need for the anchors and bores 14 mentioned above, which simplifies the construction of the attachment plate 10 and the mating carrier C. More importantly, the slidable construction of the bearing block 64 on the slide rail 22 allows the rail 22 to slide through the bearing block 54 under the downward force exerted by the weight of the article A. This prevents the force from being transferred to the vehicle and, thus, prevents damage, such as dents, on the vehicle. Alternatively, a pad of compressible, non-slip material may be used as the rail support means 50. The bearing block 54 is mounted on the side of the slide rail 22 that is opposite the cradle 30. For illustration purposes, FIG. 6A shows the bearing block 54 and the suction device 52 from the side that attaches to the vehicle.

FIG. 9 shows another embodiment of the loading slide 20 and the stop mechanism 40. The slide plate 37 is mounted on the slide rail 22. The slide rail 22 is similar to the rail shown in FIGS. 6A and 6B but with a central portion of the upper rib removed to form an open central recess. A ramp track 49 is assembled in this central recess. The stop mechanism 40 includes the ramp track 49, which includes a series of ramps, and the locking pin 47 that is assembled in the loading cradle 30. Each ramp has a stop surface 49A, which serves to prevent the locking pin 47 and the slide plate 37 from slipping downward. The locking pin 47 is ideally a spring-biased, plunger type locking pin. The spring-biased locking pin 47 and the orientation of the ramps 49 allow the user to slide the slide plate 37 over the individual ramps in the ramp track 49 in the upward direction, without having to pull against the spring-biasing mechanism on the locking pin 47. The pin 47 and the slide plate 37, however, are prevented from inadvertently sliding down the slide rail 22 by the stop surface 49A of the ramp 49 that is below the pin. The user slides the slide plate 37 downward along the slide rail 22 by pulling the locking pin 47 away from the ramp track 49. In another embodiment of the lock mechanism 40, a series of holes 43 may be provided on the slide rail 22 for receiving the locking pin 47. A single hole 43 is shown in FIG. 6B, and it is understood that a series of holes 43 may be provided along the slide rail 22 similarly to the stop buttons 42 shown in FIG. 2B.

FIGS. 7 and 8 illustrate the loading system 100 in use. In FIG. 7, two loading systems 100 are attached to two carriers C. The slide rail 20 is fully extended, bringing the loading cradle 30 down close to the ground or to a comfortable loading height. The kayak is placed in the loading cradles 30 of both loading systems 100. The user goes to a first loading system and slides one of the loading cradles 30 upward over the next higher stop button 42 on the loading slide 20 until the button pops out beneath the lower edge of the support cradle 36. The user then goes to the second loading system and slides the loading cradle 30 up on that loading slide 20 until next higher stop button pops out beneath the support cradle 36. The user now goes back to the first loading system 100 and slides the loading cradle 30 up another step and repeats these steps on the first and second loading systems 100 until the slide bar 32 is as far as it can go on the loading slide 20. At this point, the kayak is position just below the loading ramp CR on the carrier C. The kayak is then easily pushed up by hand over the loading ramp CR into the cradle CC of the carrier C.

It is understood that the embodiments described herein are merely illustrative of the present invention. Variations in the construction of the loading system may be contemplated by one skilled in the art without limiting the intended scope of the invention herein disclosed and as defined by the following claims.

What is claimed is:

1. A loading system for a vehicle roofrack, said loading system comprising:
a slide rail;
a cradle that is slidably mounted on said slide rail;
a locking mechanism for preventing said cradle from inadvertently sliding down said slide rail; and
an attachment plate adapted for attaching said slide rail to an article carrier.

2. The loading system of claim 1, wherein said cradle includes a slide plate that is mounted on said slide rail and a cradle bar that is mounted on said slide plate, and wherein said locking mechanism includes a lock pin that is assembled on said slide plate and a receiver for said lock pin on said slide rail.

3. The loading system of claim 2, wherein said slide rail has a bottom end and said locking mechanism includes a ramp track having one or more ramps, each ramp rising progressively outward from said slide rail as a distance from said bottom end increases, said each ramp having a stop surface on an upper end of said ramp, said stop surface interrupting a downward slide of said lock pin when said lock pin is in a locking position.

4. The loading system of claim 3, wherein said lock pin is a spring-biased lock pin that is biased to extend in toward said slide rail.

5. The loading system of claim 2, wherein said slide rail includes apertures for receiving said lock pin.

6. The loading system of claim 1, said carrier having a loading ramp and said loading system further comprising a removably attachable fastener for securing said attachment plate to said loading ramp.

7. The loading system of claim 6, wherein said attachment plate has a first plate and a second plate and a flexible hinge therebetween.

8. The loading system of claim 6, wherein said attachment plate is a rigid component have a first plate and a second plate formed in a fixed relationship to each other.

9. The loading system of claim 6, said loading ramp having a bore and said attachment plate having an anchor that is receivable in said bore, wherein said anchor, when inserted into said bore, cooperates with said attachment system to prevent said attachment plate from rotating about said fastener.

10. The loading system of claim 6, wherein said removably attachable fastener includes a threaded bore in said attachment plate, a through-bore on said carrier, and a threaded post that is insertable through said through-bore and into said threaded bore, so as to removably fasten said attachment plate to said carrier.

11. The loading system of claim 1 further comprising a rail support means that is adapted to support said slide rail against a vehicle, wherein said slide rail has a first side on which said cradle is mounted and a second side that is on a side of said slide rail that is opposite said first side, and wherein said rail support means is mounted on said second side of said slide rail.

12. The loading system of claim 11, wherein said rail support means is a suction cup that is mounted on said second side and that is adapted to provide a suction attachment to said vehicle.

13. The loading system of claim 11, wherein said rail support means is a pad of compressible material that is affixed to said second side of said slide rail, so as to provide a non-slip cushion attachment with said vehicle.
